(19) United States
(12) Patent Application Publication
(10) Pub. No.: US 2014/0262985 A1
(43) Pub. Date: Sep. 18, 2014

(54) Organic Waste Liquid Solid Separator

(71) Applicant: OrgAmi, LLC, Raleigh, NC (US)

(72) Inventors: Josephine Scott Dorsett, Raleigh, NC (US); James E. White, New Bern, NC (US)

(21) Appl. No.: 14/239,235

(22) PCT Filed: Aug. 17, 2012
(86) PCT No.: PCT/US2012/051320

§ 371 Date: Jun. 9, 2014

Related U.S. Application Data
(60) Provisional application No. 61/524,955, filed on Aug. 18, 2011.

(51) Int. Cl. B01D 33/00; B01D 33/11

(52) U.S. Cl. CPC B01D 33/0067; B01D 33/0009; B01D 33/11
USPC 210/86; 210/385; 210/373; 210/251

(57) ABSTRACT

The invention provides an apparatus for separating mixed organic waste material into liquid and solid components. The apparatus may include an inlet pipe having openings at a bottom portion and top portion thereof; a front plate having an opening, wherein the front plate is connected to the inlet pipe at the inlet pipe opening, such that the front plate opening and inlet pipe opening align; a drum strainer capable of rotational and linear movement; a spindle assembly operatively connected to the drum strainer, wherein the spindle assembly facilitates rotational and linear movement of the drum strainer; a scraper plate fixed to an end portion of a shaft of the spindle assembly; a shroud connected to the spindle assembly, wherein the shroud is spaced apart from and substantially covers the exterior surface of the drum strainer; and wherein the drum strainer is positioned between the front plate and scraper plate.

### 1 FIELD OF THE INVENTION

The invention relates to a system and apparatus for collecting mixed waste material, such as organic waste, and separating the mixed waste into liquids and solids. More specifically, the invention relates to a system and apparatus that collects mixed organic waste, such as organic kitchen waste, in a clean and easily transportable form, thereby removing it from the water supply and allowing its reuse as compost/fertilizer, biofuel, or any other manner in which organic material can be utilized.

### 2 BACKGROUND OF THE INVENTION

As the world's population continues to grow, that population has begun to encroach upon available natural resources, and has caused significant damage to the environment. Many different organizations and governments have begun to focus on preserving such resources and limiting damage to the environment. Some of the many approaches adopted involve promoting recycling and protection of natural water resources.

It has become especially important to preserve water resources and protect water quality given recent extensive droughts throughout different portions of the world. One area of interest is the effect of organic waste, such as organic kitchen waste, on the water supply. More specifically, current city sewer systems make it easy to introduce such waste into the water supply system, both because a significant amount of organic liquid kitchen waste flows directly into the municipal water supply, and because such sewer systems permit city residents to install disposals in their sinks, allowing the introduction of solid organic waste directly into the water supply.

Accordingly, what is needed is a way to collect and separate liquid from solid organic waste, such as organic kitchen waste, and recycle it and reduce its introduction into the water supply, for example as currently occurs as a result of using waste disposal units (garbage disposals); and from municipal landfills as currently occurs through the conventional trash removal system. What is further needed is the ability to cleanly and easily collect and reuse such waste, for example, as compost/fertilizer, biofuel, or any other manner in which organic waste material can be utilized.

### 3 BRIEF DESCRIPTION OF THE INVENTION

The invention provides, in one embodiment, an apparatus for separating mixed organic waste material into liquid and solid components. The apparatus may include an inlet pipe having openings at a bottom portion and top portion thereof; a front plate having an opening, wherein the front plate is connected to the inlet pipe at the inlet pipe opening, such that the front plate opening and the opening at the bottom portion of the inlet pipe align; a drum strainer capable of rotational and linear movement; a spindle assembly operatively connected to the drum strainer, wherein the spindle assembly facilitates the rotational and linear movement of the drum strainer; a scraper plate fixed to an end portion of a shaft of the spindle assembly; and a shroud substantially covering the exterior surface of the drum strainer, wherein the drum strainer may be positioned between the front plate and scraper plate.

The drum strainer, the front plate, and the scraper plate defining an interior region of the drum strainer within which mixed waste material may be received via the inlet pipe. The front plate may be connected to the inlet pipe such that it is perpendicular to a central axis of the opening at the bottom portion of the inlet pipe. The drum strainer may be connected to the spindle assembly by a drum bracket, wherein the drum bracket may be operatively associated with one or more rotational bearings to allow rotational movement of the drum strainer about a shaft of the spindle assembly. The apparatus may further include a rotational motor and a gear assembly, wherein the gear assembly is operatively connected to the drum bracket, and the rotational motor is operatively connected to the gear assembly to impart rotational movement to the gear assembly causing the drum bracket and drum strainer to rotate. The apparatus may further include a motor configured to impart linear movement, the motor operatively connected to the spindle assembly to impart linear movement to at least the drum strainer and spindle assembly along the spindle assembly shaft. The spindle shaft, scraper plate, front plate and inlet pipe are preferably substantially stationary during operation of the apparatus. The apparatus may further include a liquid waste discharge hose connected to the shroud. The apparatus may further include a discharge door positioned below the strainer drum, wherein the discharge door is operatively connected to the spindle assembly such that the spindle assembly may cause the discharge door to move in the same linear direction with the drum strainer. The strainer drum preferably rotates at a sufficient rate to substantially separate liquid waste material from solid waste material, and the liquid waste is caused to be discharged through a plurality of openings in the strainer drum, wherein the liquid waste is constrained and directed by the shroud to the liquid waste discharge hose, and wherein the solid waste is caused to be discharged from the strainer drum interior region via a scrapping action of the scraper plate. The face plate and scraper plate have a slightly smaller diameter than an internal diameter of the drum strainer. A front portion and back portion of the drum strainer preferably overlaps at least a portion of a perimeter edge of the face plate and the scraper plate respectively. The scraper plate may be held stationary as the drum strainer moves and may be operative to perform a scraping action to move accumulated solid waste from an interior of the drum strainer. The rotational rate of the drum strainer may be in the range of about 70 to about 80 revolutions per minute, and may be in the range of about 74 to about 75 rpm. The spindle assembly and spindle assembly shaft are operatively engaged with one or more axial bearings to facilitate the liner movement of the spindle assembly along the spindle assembly shaft. The opening at the top portion of the inlet pipe may be connected to a sink. The apparatus further may include a valve positioned in the inlet pipe upper portion in proximity to the connection of the inlet pipe to the sink. The valve may be a ball valve, and may either be a manual or automatic valve. The apparatus further may include a solid waste collector positioned below the drum strainer and is configured to collect solid waste discharged from the strainer drum interior region. The solid waste collector may include a manual pod bagger. The manual pod bagger may include a continuous open sleeve of material and a sleeve tube, wherein the continuous open sleeve of material may be accumulated in the sleeve tube. The solid waste collector may include an automatic pod bagger. The automatic pod bagger may include a continuous open sleeve of material; a sleeve tube, wherein the continuous open sleeve of material is accumulated in the sleeve tube; a sleeve advancement clamp operatively associated with and positioned below sleeve tube and configured to engage a portion of the continuous open sleeve of material to advance a defined length of continuous open sleeve of material from the sleeve tube; an upper sealer; a lower sealer; and a cutter, wherein the upper sealer, lower sealer, and cutter are in operative association with and positioned above the sleeve advancement clamp, and wherein the upper sealer is positioned below the lower sealer and the cutter is located between the upper sealer and the lower sealer, and wherein the upper sealer, lower sealer, and cutter comprise an assembly.

The invention provides, in another embodiment, a system for separating mixed waste material into liquid and solid components. The system may include a housing; a solid liquid separator housed in an interior region of the housing; a solid waste wrap and seal compartment housed in the interior region of the housing and positioned below the solid liquid separator, wherein the solid waste wrap and seal compartment is configured to collect and seal solid waste material separated out from the solid liquid separator; and a solid waste receptacle housed in the interior region of the housing and positioned below the solid waste wrap and seal compartment, wherein the solid waste receptacle is configured to collect sealed solid waste material from the solid waste wrap and seal compartment. The solid liquid separator may include an inlet pipe having openings at a bottom portion and top portion thereof; a front plate having an opening, wherein the front plate is connected to the inlet pipe at the inlet pipe opening, such that the front plate opening and the opening at the bottom portion of the inlet pipe align; a spindle assembly operatively connected to the drum strainer, wherein the spindle assembly facilitates the rotational and linear movement of the drum strainer; a scraper plate fixed to an end portion of a shaft of the spindle assembly; a shroud connected to the spindle assembly, wherein the shroud is spaced apart from and substantially covers the exterior surface of the drum strainer; and wherein the drum strainer may be positioned between the front plate and scraper plate.

The system may further include a lid, wherein the lid provides access to the opening at the top portion of the inlet pipe. The housing may further include a liquid waste container fluidly connected to the liquid waste discharge hose. The housing may further include a solid waste receptacle housing, wherein the solid waste receptacle may be house therein. The liquid waste container may further include a liquid level indicator.

### 4 BRIEF DESCRIPTION OF THE DRAWINGS

FIG. 1 illustrates a solid liquid separator consistent with certain embodiments of the invention;

FIG. 2 illustrates a cross-sectional view of a solid liquid separator consistent with certain embodiments of the invention;

FIG. 3A illustrates a waste catch basin attached to a solid liquid separator consistent with certain embodiments of the invention;

FIG. 3B illustrates a manual pod bagger attached to a solid liquid separator consistent with certain embodiments of the invention;

FIG. 3C illustrates an automatic pod bagger attached to a solid liquid separator consistent with certain embodiments of the invention;

FIG. 4A illustrates an interior view of a standalone system with a solid liquid separator, manual pod bagger, and pod receptacle consistent with certain embodiments of the invention;

FIG. 4B illustrates an interior view of a standalone system with a solid liquid separator, an automatic pod bagger, and pod receptacle consistent with certain embodiments of the invention;

FIG. 5A illustrates a stand-alone organic waste wrap and removal apparatus with a pod receptacle consistent with certain embodiments of the invention;

FIG. 5B illustrates an interior view of a stand-alone mixed waste wrap and removal apparatus with manual pod bagger and pod receptacle consistent with certain embodiments of the invention; and

FIG. 5C illustrates an interior view of a stand-alone mixed waste wrap and removal apparatus with an automatic pod bagger and pod receptacle consistent with certain embodiments of the invention.

### 5 DETAILED DESCRIPTION OF THE INVENTION

The present invention discloses a system and apparatus for the separation of liquid and solid mixed waste, such as organic waste, for example, organic kitchen waste/scraps. The system may incorporate a device with a sink, such as a kitchen sink, or other waste disposal device used to dispose of mixed waste including any debris having both solid and liquid components, or may be a stand-alone system.

FIG. 1 illustrates a solid liquid separator 100 for the separation of liquid and solid waste materials, such as organic waste material, consistent with certain embodiments of the invention. In this exemplary embodiment the solid liquid separator 100 accepts mixed solid and liquid waste, for example, organic waste, such as food, other mixed organic kitchen debris, organic debris from a household or commercial kitchen operation, or any mixture of solid and liquid waste, and separates the solid waste material from the liquid waste material, such that the solid and liquid waste material may be individually collected, recycled, composted, or otherwise disposed of in a more ecologically friendly manner. The solid liquid separator 100 may be connected to a sink (such as shown in FIGS. 3A-C) or other material disposal device through an inlet pipe 102. The inlet pipe 102 is connected to an outflow opening at the base of the sink or other waste disposal device and provides a pathway for mixed waste material, such as organic kitchen waste, to move from the sink, in a non-limiting example, into the solid liquid separator 100 for processing. The inlet pipe 102 may be in the range of about two (2) inches in diameter and of a length sufficient to connect the sink to the solid liquid separator 100. The inlet pipe 102 enters the solid liquid separator 100 through an opening 203 (shown in FIG. 2). Front plate 104 is preferably attached to inlet pipe 102 at opening 203 and has an opening corresponding with opening 203 to allow the passage of mixed waste material there through. Front plate 104 is sized and positioned such that it operates to help confine the incoming mixed waste inside the drum strainer 200 (shown in FIG. 2) of solid liquid separator 100 during the solid liquid separation processing of the mixed waste material. In one example, front plate 104 is preferably of a diameter slightly less than that of the interior diameter of drum strainer 200. The solid liquid separator 100 is preferably mounted such that it is perpendicular to a central axis of the opening 203 of the inlet pipe 102. This orientation places the front plate 104 and the rest of the apparatus perpendicular to the central axis of the opening 203 of the inlet pipe 102 as well. This orientation permits the inlet pipe 102 to introduce mixed waste material to an interior region of the solid liquid separator 100 device through the opening 203, which is preferably formed at a center of the front plate 104.

The solid liquid separator 100 may include a shroud 106 that functions to help prevent leakage of mixed waste material that is introduced to the system through the inlet pipe 102, as well as to constrain and collect the liquid waste material during the solid liquid separation processing. Solid liquid separator 100 may further include a spindle assembly 108 operatively connected thereto to provide both rotational and linear movement of certain components of the solid liquid separator 100 as described in more detail below. The spindle assembly 108 is preferably secured to a support structure, such as an interior wall of a cabinet, or other suitable mounting location, and is held in place by a spindle assembly support shaft 110. The assembly support shaft 110 is operative to provide a stable mounting for the solid liquid separator 100 during operation. The solid liquid separator 100 also may include a motor 112, such as an electric motor that is operative to provide linear movement of certain components of the solid liquid separator 100, preferably including the spindle assembly 108, drum strainer 200, shroud 106, and discharge lid 118 as may be required during the liquid solid separation process of the mixed waste material. Motor 112 may be mounted to or in close proximity to a base plate 111 of spindle assembly support shaft 110, or at any location suitable to provide the required linear movement. When activated, in one non-limiting example, the motor 112 causes a shaft 113, connected through a turnbuckle 114 to a back side of the spindle assembly 108, to rotate. Rotating the shaft 113 through the turnbuckle 114 in one direction will cause spindle assembly 108, drum strainer 200, shroud 106, and discharge lid 118 to move in a linear direction from an initial position toward the base plate 111 of the spindle assembly support shaft 110 to a secondary position. Rotating the shaft 113 through the turnbuckle 114 in an opposite direction will cause the spindle assembly 108, drum strainer 200, shroud 106, and discharge lid 118 to move in a linear direction away from the base plate 111 of the spindle assembly support shaft 110 and back to its initial position.

The solid liquid separator 100 shroud 106 also has a liquid discharge hose 116 that permits the egress of separated waste liquid material collected in the shroud 106 during waste separation operations. The liquid discharge hose 116 may be connected to a reservoir or other device used for containing liquids and may then be re-used as grey water for plants or other purposes. Alternatively, liquid discharge hose 116 may be connected to an existing sink drain line or other waste water drain line. The solids discharge door 118 is preferably attached to the spindle assembly 108, such that it covers a solid waste catch basin 120 when the solid liquid separator 100 is in its initial position. In this exemplary embodiment the solid waste catch basin 120 is held in place beneath the solids discharge door 118 by mounting brackets 122. The solid waste catch basin 120 may, in a certain embodiment, be placed manually in the mounting brackets 122 and removed manually when the solid waste catch basin 120 needs to be emptied. In an alternative embodiment solid waste catch basin 120 is replace with a manual or automatic pod bagger as described in more detail below with reference to FIGS. 3B and 3C.

FIG. 2 illustrates a cross-sectional view of the solid liquid separator 100 consistent with certain embodiments of the invention. In an exemplary embodiment, when a user places mixed waste material (e.g., liquid and solid organic kitchen waste) into inlet pipe 102 the waste is gravity fed into the solid liquid separator 100 and into drum strainer 200 via opening 203. A user may use water to help the mixed waste travel down inlet pipe 102 and into an interior region of drum strainer 200. The drum strainer 200 preferably has a circular cross section and is mounted perpendicular to the center axis of the opening 203 of the inlet pipe 102 such that the mixed waste material placed in the inlet pipe 102 enters the drum strainer 200 at substantially a center point of the circular area defined by the drum strainer 200. The drum strainer 200 has a plurality of strainer openings 202 that penetrate the surface of the drum strainer 200 walls and are of a sufficient size so as to permit the passage of liquid waste material as it is separated from the input mixed waste material while constraining the exit of solid waste material. The strainer openings 202 may be of any size sufficient to permit the discharge of liquid while retaining the solid portion of the mixed waste material input into the drum strainer 200 of the solid liquid separator 100. On the other side of the drum strainer 200, opposite the face plate 104 and the waste inlet pipe 102, is a scraper plate 204 that forms the back side constraint against the input mixed waste material falling out of the drum strainer 200. The scraper plate 204 is also operative to scrape solid waste out of the drum strainer 200 at the end of a waste separation operation. The scraper plate 204 is preferably a circular plate and is attached to the spindle assembly support shaft 110 at a center portion of the scraper plate 204. Scraper plate 204 is preferably of a diameter slightly less than that of the interior diameter of drum strainer 200, such that scraper plate 204 is capable of scrapping the inner surface of drum strainer 200. The drum strainer 200 is supported in place by a drum bracket 205 that isolates the drum strainer 200 from the shroud 106, front plate 104, and scraper plate 204 while allowing the drum strainer 200 to move freely in a rotation motion during operation. The drum strainer 200, when activated, is rotated at a rate in the range of about 70 to about 80 revolutions per minute (rpm) to facilitate the separation of the solid and liquid waste material components. In one embodiment the drum strainer 200 spins at a rate in the range of about 74 to about 75 rpm. However, other rates of more or less that about 70 to about 80 rpm are contemplated by the invention, the exact rate being determined based on the amount and makeup of the mixed waste material in the drum strainer 200. The drum strainer 200 may spin for a defined amount of time to sufficiently separate the solid and liquid waste material. In one example, the drum strainer 200 may spin in the range of about five (5) to about 15 seconds. However, based on the waste material more or less time may be required and the spin time can be adjusted accordingly.

The drum shroud 106 is preferably spaced away from and substantially covers the exterior of the drum strainer 200 to contain and direct liquid waste material separated from the mixed waste material during the solid liquid separation process. Drum shroud 106 is preferably connected to the spindle assembly 108 by a shroud support arm 206. The spindle assembly 108 provides the rotational and linear forces to both rotate the drum strainer 200 and move the drum strainer 200, spindle assembly 108, shroud 106, and discharge lid 118 in a linear direction as required during the waste separation process. The drum bracket 205 is operatively engaged in a rotating manner with rotational bearings 208, which are positioned in an operative manner on spacer 210 to isolate the rotational bearings 208 from axial bearings 212 thus isolating the rotational movement from the linear movement. The rotational bearings 208 are positioned and configured to permit the drum strainer bracket 205 and drum strainer 200 to rotate in a rotational motion about the spindle assembly support shaft 110 when in operation. This rotational motion of the drum strainer 200 expels liquid waste from the mixed waste material in the drum strainer 200, by centrifugal and gravitational forces, through the strainer openings 202. The liquid waste expelled from the drum strainer 200, collects in the shroud 106 and is directed to liquid discharge hose 116 to be collected in a container or otherwise drained. The rotational motion of the drum strainer 200 is accomplished by a rotational motor 214. When activated, the rotational motor 214 is connected to a rotation gear 215 that translates the energy from the rotational motor 214 to a rotational gear 216 connected to the drum bracket 205 such that as rotational gear 216 is rotated drum bracket 205 is rotated, which in turn rotates the drum strainer 200 to perform the mixed waste solid liquid separation process.

When activated, the rotational motor 214 rotates the drum strainer 200 at a predefined speed for a pre-determined period of time, which is set to balance the amount of energy consumed by the motor against the removal of a substantial amount of the liquid from the mixed waste material input into the solid liquid separator 100. In one non-limiting example, the drum strainer 200 is rotated at a rate in the range of about 70-80 rpm for about five (5) to about 15 seconds. Upon the completion of this time period, the rotational motor 214 may continue to rotate, but at a slower rate from that used during the solid liquid separation process, to a range of about 10 to 20 rpm. Alternatively, after the solid liquid separation process the drum strainer 200 may rotate at a rate of more or less than about 10 to about 20 rpm, or may not rotate at all. After the solid liquid separation process, motor 112 is activated to move the spindle assembly 108, drum strainer 200, shroud 106, and discharge lid 118 in a linear motion from the initial position during the waste separation operation toward the base plate 111 of the spindle assembly support shaft 110 to a secondary position. The spindle assembly 108, to which the drum bracket 204 (and thus drum strainer 200), shroud 106, and discharge lid 118 are all operatively connected to, travel along a set of axial bearings 218 to smoothly move the drum strainer 200 past the stationary drum scraper plate 204, which has a slightly smaller diameter than the inside diameter of the drum strainer 200. The diameter of drum scraper plate 204 is preferably of a size such that an outer perimeter of the drum scraper plate 204 is nearly flush against the inside diameter of the drum strainer 200. As the drum strainer 200 moves in a linear motion it may continue to rotate at about 10 to about 15 rpm, or alternatively the drum strainer 200 does not continue to rotate, permitting the drum scraper plate 204 to scrape all collected solid waste material from the interior of the drum strainer 200 and pushes the solid waste material out of the drum strainer 200. The solid discharge door 118 moves in the linear direction with the shroud 106 and the drum strainer 200 during the scraping operation to allow the collected solids to be discharged into a solids collection area, such as solid waste catch basin 120.

When the scraping operation is complete, the motor 112 activates and causes linear motion in the opposite direction. This reverses the linear direction of the spindle assembly 108, drum strainer 200, shroud 106 and discharge lid 118 and returns them to their initial position. The discharge door 118, when moved back to its initial position, closes the solids discharge area when the system is not in use to help prevent odors from escaping. If drum strainer 200 is still rotating, the rotation motor 214 stops the rotational motion of the drum strainer 200 and the solid liquid separator 100 is in a ready state for the next operation as needed.

FIG. 3A illustrates a solid liquid separator 100 attached to a sink basin 300, and including a solid waste catch basin 120 attached thereto consistent with certain embodiments of the invention. The sink basin 300 may be a sink or other basin commonly present in both residential and commercial kitchens. This non-limiting example presents the solid liquid separator 100 in a configuration that provides a solid waste catch basin 120 that may be manually inserted and removed when the solid waste catch basin 120 is full. In this embodiment, waste is input to the solid liquid separator 100 by depositing mixed waste material, such as food scraps and/or other organic kitchen waste into the inlet pipe 102 via a valve 302, such as a ball valve or other suitable valve type, located near a top portion of the inlet pipe 102. Valve 302, may include a valve actuator 303, and may be either a manual or automatic valve. To begin the waste separation operation, a user preferably activates the solid liquid separator 100 by activating a start button, for example the user may push a start button, or activate some other trigger, switch or other suitable activation mechanism. Upon activation, the valve 302 closes to prevent regurgitation of any liquid or solid waste material back up into the sink basin 300. In a preferred embodiment, the valve 302 is an automatic ball valve, and upon activation of the system, actuator 303 is activated and automatically closes the valve 302. The mixed waste material enters the solid liquid separator 100 via inlet pipe 102 and passes through opening 203 into an interior region of drum strainer 200, where the solid waste is constrained by the interior walls of the drum strainer 200, the front plate 104, and scraper plate 204, and the liquid waste is constrained by the shroud 106 during the solid liquid separation operation. Once the valve 302 closes, the solid liquid separator 100 senses, for example, via a sensor switch, such as a micro switch, that the valve 302 is closed and initiates rotation of the drum strainer 200 at a pre-determined rotation rate and for a pre-determined amount of time to effectively separate the liquid waste material from the solid waste material. In one example, the drum strainer 200 is rotated for a period of about five (5) to about 10 seconds and at a rate of about 74 to about 75 rpm. During this portion of the solid liquid separation process, the liquid waste material is separated out from the input mixed waste material by the centrifugal forces caused by the rotation of the drum strainer 200 and gravity, and is forced through strainer openings 202 and collected by the shroud 106 and directed to the liquid discharge hose 116 for collection or drainage. The remaining solid waste material is contained in the interior of drum strainer 200.

Upon termination of the pre-determined amount of time, motor 112, such as a linear movement motor with a turnbuckle, activates and causes the spindle assembly 108, drum strainer 200, shroud 106 and discharge lid 118 to move in a linear direction from an initial position toward base plate 111 of spindle assembly support shaft 110 to a secondary position. The inlet pipe 102, front plate 104, and scraper plate 204 all remain substantially stationary. As the drum strainer 200 moves in a linear direction towards the base plate 111 of the spindle assembly support shaft 110, scraper plate 204 provides scraping effect along the interior surface of the drum strainer 200 and any solid waste collected within the internal surface and/or area of the drum strainer 200 is scraped out by scraper plate 204. The linear movement toward the base plate 111 of the spindle assembly support shaft 110 caused by motor 112 also causes discharge door 118 to open permitting the scraped solid waste to drop from the internal area of the drum strainer 200 down into the solid waste catch basin 120. Once the interior surface of the drum strainer 200 has passed over the scraper plate to allow the entire interior surface of drum strainer 200 to be scraped and to push out the solid waste material therein, a sensor switch, such as a micro-switch, senses the drum strainer 200, spindle assembly 108, shroud 106 and discharge lid 118 are in the secondary position, and the motor is activated to cause the drum strainer 200 spindle assembly 108, shroud 106 and discharge lid 118 to move in a reverse linear direction back to the initial position. Once the drum strainer 200, spindle assembly 108, shroud 106 and discharge lid 118 are returned to their initial position, a sensor switch associated with valve 302, such as a micro-switch, senses the components are back in their initial position and activates valve 302 to automatically open again. The collected solid waste material may be removed from the solid waste catch basin 120 and recycled or otherwise disposed of.

FIG. 3B illustrates a solid liquid separator 100 attached to a sink basin 300, including a manual pod bagger 305 attached thereto consistent with certain embodiments of the invention. This exemplary embodiment of solid liquid separator 100 is operationally the same as the example presented in FIG. 3A with the manual pod bagger 305 replacing the solid waste catch basin 120. The input mixed waste material is processed, again separating the liquid waste material from the solid waste material, and the solid waste material is scraped from the drum strainer 200 as detailed above with reference to FIG. 3A. In this embodiment the solid waste material is collected and bagged using manual pod bagger 305. After the interior surface of the drum strainer 200 is scraped the solid waste material drops into a bag, such as a biodegradable bag. Manual pod bagger 305 is preferably supported in position below discharge door 118 by brackets 122. Manual pod bagger 305 preferably includes a continuous open sleeve of material 314 accumulated in a sleeve tube 316. Alternatively, a prepackaged open sleeve cassette could be used. In use, manual pod bagger 305 is installed via brackets 122. The continuous open sleeve of material 314 is accumulated in the sleeve tube 316, or a prepackaged open sleeve cassette is installed. A knot 312, such as a simple over hand knot, is tied to a bottom end of the continuous open sleeve of material 314 to form a bottom of a pod 310. The continuous open sleeve of material 314 with tied bottom is pulled in a downward direction a distance to form a desired size pod 310. After an amount of solid waste from drum strainer 200 has been deposited into pod 310 and/or at a predetermined time a user then ties a second knot 312, such as a simple over hand knot, above the solid waste level to seal the solid waste in pod 310. A cutting device can be used to cut the sealed pod 310 from the continuous open sleeve of material 314. The user then pulls the continuous open sleeve of material 314 in downward direction to form the next desired size pod 310, and a knot 312 is tied to the bottom of the continuous open sleeve of material 314 to form the bottom of the next pod 310. Alternatively, the user may cut the pod 310 from the continuous open sleeve of material 314 prior to tying the second knot 312 and then seal the pod 310 after separating it from the continuous open sleeve material 314. In another alternative embodiment, the continuous open sleeve of material 314 may have perforations at set intervals along its length to facilitate separating into defined pod sizes, for example instead of using a cutting instrument to separate a pod 310 the user could simply tear along the perforations.

FIG. 3C illustrates a solid liquid separator 100 attached to a sink basin 300, including an automatic pod bagger 330 attached thereto consistent with certain embodiments of the invention. This exemplary embodiment of the solid liquid separator 100 is operationally the same as the example presented in FIG. 3A, with the automatic pod bagger 330 replacing the solid waste catch basin 120. The input mixed waste material is processed, again separating the liquid waste material from the solid waste material, and the solid waste material is scraped from the drum strainer 200, as detailed above with reference to FIG. 3A. In this embodiment the solid waste material is collected and bagged using automatic pod bagger 330. After the interior surface of the drum strainer 200 is scraped the solid waste material drops into a bag, such as a biodegradable bag. Automatic pod bagger 330 is preferably secured in position below discharge door 118 by brackets 122. Automatic pod bagger 330 preferably includes a continuous open sleeve of material 314 accumulated in a sleeve tube 316 having an open inside diameter. Alternatively, a prepackaged open sleeve cassette could be used. Automatic pod bagger 330 further includes a sleeve advancement clamp 340 operatively associated with and positioned below sleeve tube 316. Automatic pod bagger 330 further includes an upper sealer 336, a lower sealer 332, and a cutter 338 in operative association with sleeve advancement clamp 340, wherein the upper sealer 336 is positioned below lower sealer 332 and the cutter 338 is located between the upper sealer 336 and lower sealer 332. The upper sealer 336, lower sealer 332, and cutter 338 preferably comprise an assembly and are positioned above sleeve advancement clamp 340. In use, sleeve tube 316 is installed via brackets 122. Continuous open sleeve of material 314 is accumulated in the sleeve tube 316, or alternatively a prepackaged open sleeve cassette is used. Continuous open sleeve of material 314 is initially passed through the open inside diameter of sleeve tube 316 and past sleeve advancement clamp 340. The continuous open sleeve of material 314 maybe initially passed through the inside diameter of sleeve tube 316 and through sleeve advancement clamp 340 by a user manually pulling at an end portion of the continuous open sleeve of material 314 in a downward direction. Once an end portion of the continuous open sleeve of material 314 is initially passed through the inside diameter of sleeve tube 316 and through sleeve advancement clamp 340, an automatic seal cycle is initiated to form a seal across the end portion of the continuous open sleeve of material 314 to form a bottom of a pod 310. The automatic pod bagger 330 is now ready to receive and bag solid waste material from solid liquid separator 100. After an initial cycle of the system, i.e., solid liquid separation process and solid waste material discharge, the system's firmware activates the sleeve advancement clamp 340 to clamp and grip the bottom portion of pod 310 and indexes downward in a linear direction to a predetermined setting, e.g., as preset or as set by the user. This allows the user to set the pod 310 to any length that will function in the range of the solid liquid separator 100. After sleeve advancement clamp 340 has completed its cycle and the pod 310 has a sufficient amount of solid waste material collected therein, the upper sealer 336 and lower sealer 332 both activate. The upper sealer 336 seals the bottom of the next pod 310 and the lower sealer 332 seals the top of present pod 310. Both upper sealer 336 and lower sealer 332 are programmed or otherwise set to operate at temperatures suitable for sealing the sleeve material 314 based on the specific sleeve material 314 type parameters, and may be adjustable to accommodate different types of sleeve material 314 having differing parameters. After sealing is complete, cutter 338, which is preferably positioned between upper sealer 336 and lower sealer 332 separates a finished sealed pod 310 from the bottom of a next pod 310. Finished sealed pods 310 then preferably drop into pod receptacle, which may be removable for ease of emptying.

Alternatively, or in combination with the sensor switches, a system firmware may be provided and programmed to activate the various operations of the solid liquid separator 100.

FIG. 4A illustrates an internal view of a stand-alone waste removal apparatus 400 including a solid liquid separator 100 with a manual pod bagger 305 and pod receptacle 416 consistent with certain embodiments of the invention. This exemplary implementation presents a waste removal apparatus 400 having the solid liquid separator 100 with manual pod bagger 305 and pod receptacle 416 installed within a purpose built housing 401, such as a cabinet, that may be placed, for example, within a domestic or commercial kitchen. The top of the housing 401 preferably includes a lid 402 that is an entry point for the deposit of mixed waste material, such as organic waste, into the waste removal apparatus 400. Lid 402 may be a hinged, slideable, or other suitable type lid, and may be opened by hand or foot lever, by a push or pull lever, hand sensor technology, or other suitable means, and lid 402 may, for example, tilt back, tilt down, or slide open for easy access to an opening to waste inlet pipe 102 for deposit of mixed waste material. The deposited mixed waste material enters drum strainer 200 of the solid liquid separator 100 through waste inlet pipe 102 and waste separation operations are performed as described above, for example, with reference to FIGS. 2 and 3B. The separated out liquid waste material drains out of the drum strainer 200 and is collected and directed by shroud 106 to the liquid discharge hose 116 and drained into a purpose built liquid waste container 408. An indication of the level of waste liquid held in the liquid waste container 408 may be measured by a liquid level indicator 410, which may be formed on the liquid waste container 408. In one embodiment liquid level indicator 410 includes a clear window to visually indicate the amount of liquid waste contained in the liquid waste container 408. Alternatively, a float and gauge mechanism, or any other suitable mechanism for measuring a liquid level in a container could be used. In yet another alternative embodiment, the separated out liquid waste material drains out of the drum strainer 200 and is collected and directed by shroud 106 to the liquid discharge hose 116 and drained into an existing waste water discharge drain line, such as a residential sink drain line. The separated out solid waste material is bagged via manual pod bagger 305 through operations as described above with reference to FIG. 3B. The pods 310 of solid waste material preferably are collected in a pod receptacle 416 that is capable of holding a plurality of pods 310 and may be removable by the user for ease of emptying the container. In one embodiment, the pod receptacle 416 is housed in a receptacle housing 417, which may be a drawer or cabinet structure that can be opened to access the pod receptacle 416 for easy removal and emptying of pods 310. Receptacle housing 417, may, for example, be a swivel, tilt, or slideable type drawer or cabinet structure.

FIG. 4B illustrates an internal view of a stand-alone waste removal apparatus 400 including a solid liquid separator 100 with an automatic pod bagger 330 and pod receptacle 416 consistent with certain embodiments of the invention. This exemplary implementation presents a waste removal apparatus 400 having the solid liquid separator 100 with automatic pod bagger 330 and pod receptacle 416 installed within a purpose built housing 401, such as a cabinet, that may be placed, for example, within a domestic or commercial kitchen. The top of the housing 401 preferably includes a lid 402 that is an entry point for the deposit of mixed waste material, such as organic waste, into the waste removal apparatus 400. Lid 402 may be a hinged, slideable, or other suitable type lid, and may be opened by a hand or foot lever, by a push or pull lever, hand sensor technology, or other suitable means, and lid 402 may, for example, tilt back, tilt down, or slide open for easy access to an opening to waste inlet pipe 102 for deposit of mixed waste material. The deposited mixed waste material enters drum strainer 200 of the solid liquid separator 100 through waste inlet pipe 102 and waste separation operations are performed as described above, for example, with reference to FIGS. 2 and 3C. The separated out liquid waste material drains out of the drum strainer 200 and is collected and directed by shroud 106 to the liquid discharge hose 116 and drained into a purpose built liquid waste container 408. An indication of the level of waste liquid held in the liquid waste container 408 may be measured by a liquid level indicator 410, which may be formed on the liquid waste container 408. In one embodiment liquid level indicator 410 includes a clear window to allow a visual indicator of the amount of liquid waste contained in the liquid waste container 408. Alternatively, a float and gauge mechanism, or any other suitable mechanism for measuring a liquid level in a container could be used. In yet another alternative embodiment, the separated out liquid waste drains out of the drum strainer 200 and is collected and directed by shroud 106 to the liquid discharge hose 116 and drained into an existing waste water discharge drain line, such as a residential sink drain line. The separated out solid waste material is bagged via the automatic pod bagger 330 through operations as described above with reference to FIG. 3C. The pods 310 of solid waste material preferably are collected in a pod receptacle 416 that is capable of holding a plurality of pods 310 and may be removable by the user for ease of emptying the container. In one embodiment, the pod receptacle 416 is housed in a receptacle housing 417, which may be a drawer or cabinet structure that can be opened to access the pod receptacle 416 for easy removal and emptying of pods 310. Receptacle housing 417, may, for example, be a swivel, tilt, or slideable type drawer or cabinet structure.

Alternatively, or in combination with the sensor switches, a system firmware may be provided and programmed to activate the various operations of the stand-alone waste removal apparatus 400.

FIG. 5A illustrates a stand-alone waste wrap and removal apparatus 500 with a pod receptacle 416 consistent with certain embodiments of the invention. In this exemplary embodiment the stand-alone waste wrap and removal apparatus 500 is composed of a housing 501, such as a cabinet structure. Preferably, housing 501 is of sufficient dimension to be installed, for example, within or next to standard domestic and commercial kitchen cabinets or appliance. The top of the housing 501 preferably includes a lid 502 that is an entry point for the deposit of waste material, such as organic waste, into the waste wrap and removal apparatus 500. Lid 502 may be a hinged, slideable, or other suitable type lid, and may be opened by hand or foot lever, by a push or pull lever, hand sensor technology, or other suitable means, and lid 502 may, for example, tilt back, tilt down, or slide open for easy access to an opening for deposit of waste material. The waste is deposited through an opening under lid 502 and into a wrap and seal compartment 504 of the waste wrap and removal apparatus 500. In the wrap and seal compartment 504, the deposited waste material is collected in, for example a bag, such as a biodegradable bag, and is bagged into pods 310 via the manual pod bagger 305 or automatic pod bagger 330 through operations as described above with reference to FIGS. 3B and 3C respectively. The pods 310 of waste material preferably are collected in a pod receptacle 416 that is capable of holding a plurality of pods 310 and may be removable by the user for ease of emptying. In one embodiment, the pod receptacle 416 is housed in a receptacle housing 417, which may be a drawer or cabinet structure that can be opened to access the pod receptacle 416 for easy removal and emptying of pods 310. Receptacle housing 417, may, for example, be a swivel, tilt, or slideable type drawer or cabinet structure.

FIG. 5B illustrates an interior view of a stand-alone waste wrap and removal apparatus 500 with a manual pod bagger 305 and pod receptacle 416 consistent with certain embodiments of the invention. In this exemplary embodiment the stand-alone waste wrap and removal apparatus 500 is composed of a housing 501, such as a cabinet structure. Preferably, housing 501 is of sufficient dimension to be installed, for example, within or next to standard domestic and commercial kitchen cabinets or appliance. The top of the housing 501 preferably includes a lid 502 that is an entry point for the deposit of waste material, such as organic waste, into the waste wrap and removal apparatus 500. Lid 502 may be a hinged, slideable, or other suitable type lid, and may be opened by hand or foot lever, by a push or pull lever, hand sensor technology, or other suitable means, and lid 502 may, for example, tilt back, tilt down, or slide open for easy access to an opening for deposit of waste material. The waste is deposited through an opening under lid 502 and into a wrap and seal compartment 504 of the waste wrap and removal apparatus 500. In the wrap and seal compartment 504, the deposited waste material is collected in, for example a bag, such as a biodegradable bag, and is bagged into pods 310 via the manual pod bagger 305 through operations as described above with reference to FIG. 3B. The pods 310 of waste material preferably are collected in a pod receptacle 416 that is capable of holding a plurality of pods 310 and may be removable by the user for ease of emptying the container. In one embodiment, the pod receptacle 416 is housed in a receptacle housing 417, which may be a drawer or cabinet structure that can be opened to access the pod receptacle 416 for easy removal and emptying of pods 310. Receptacle housing 417, may, for example, be a swivel, tilt, or slideable type drawer or cabinet structure.

FIG. 5C illustrates an interior view of a stand-alone waste wrap and removal apparatus 500 with an automatic pod bagger 3330 and pod receptacle 416 consistent with certain embodiments of the invention. In this exemplary embodiment the stand-alone waste wrap and removal apparatus 500 is composed of a housing 501, such as a cabinet structure. Preferably, housing 501 is of sufficient dimension to be installed, for example, within or next to standard domestic and commercial kitchen cabinets or appliance. The top of the housing 501 preferably includes a lid 502 that is an entry point for the deposit of waste material, such as organic waste, into the waste wrap and removal apparatus 500. Lid 502 may be a hinged, slideable, or other suitable type lid, and may be opened by a hand or foot lever, by a push or pull lever, hand sensor technology, or other suitable means, and lid 502 may, for example, tilt back, tilt down, or slide open for easy access to an opening for deposit of waste material. The waste is deposited through an opening under lid 502, and into a wrap and seal compartment 504 of the waste wrap and removal apparatus 500. In the wrap and seal compartment 504, the deposited waste material is collected in, for example a bag, such as a biodegradable bag, and is bagged into pods 310 via the automatic pod bagger 330 through operations as described above with reference to FIG. 3C. The pods 310 of waste material preferably are collected in a pod receptacle 416 that is capable of holding a plurality of pods 310 and may be removable by the user for ease of emptying the container. In one embodiment, the pod receptacle 416 is housed in a receptacle housing 417, which may be a drawer or cabinet structure that can be opened to access the pod receptacle 416 for easy removal and emptying of pods 310. Receptacle housing 417, may, for example, be a swivel, tilt, or slideable type drawer or cabinet structure.

Alternatively, or in combination with the sensor switches, a system firmware may be provided and programmed to activate the various operations of the stand-alone waste wrap and removal apparatus 500.

### 6 CONCLUDING REMARKS

The foregoing detailed description of embodiments refers to the accompanying drawings, which illustrate specific embodiments of the invention. Other embodiments having different structures and operations do not depart from the scope of the present invention. The term “the invention” or the like is used with reference to certain specific examples of the many alternative aspects or embodiments of the applicant's invention set forth in this specification, and neither its use nor its absence is intended to limit the scope of the applicant's invention or the scope of the claims. This specification is divided into sections for the convenience of the reader only. Headings should not be construed as limiting of the scope of the invention. The definitions are intended as a part of the description of the invention. It will be understood that various details of the present invention may be changed without departing from the scope of the present invention. Furthermore, the foregoing description is for the purpose of illustration only, and not for the purpose of limitation.

We claim:

1. An apparatus for separating mixed waste material into liquid and solid components comprising:
an inlet pipe having openings at a bottom portion and top portion thereof;
a front plate having an opening, wherein the front plate is connected to the inlet pipe at the inlet pipe opening, such that the front plate opening and inlet pipe opening align;
a drum strainer capable of rotational and linear movement;
a spindle assembly operatively connected to the drum strainer, wherein the spindle assembly facilitates the rotational and linear movement of the drum strainer;
a scraper plate fixed to an end portion of a shaft of the spindle assembly;
a shroud connected to the spindle assembly, wherein the shroud is spaced apart from and substantially covers the exterior surface of the drum strainer; and
wherein the drum strainer is positioned between the front plate and scraper plate.

2. The apparatus of claim 1, wherein the drum strainer, the front plate, and the scraper plate defining an interior region of the drum strainer within which mixed waste material is received via the inlet pipe.

3. The apparatus of claim 1, wherein the front plate is connected to the inlet pipe such that it is perpendicular to a central axis of the opening at the bottom portion of the inlet pipe.

4. The apparatus of claim 1, wherein the drum strainer is operatively connected to the spindle assembly by a drum bracket, wherein the drum bracket is operatively associated with one or more rotational bearings to allow rotational movement of the drum strainer about the shaft of the spindle assembly.

5. The apparatus of claim 4, further comprising a rotational motor and a gear assembly, wherein the gear assembly is operatively connected to the drum bracket, and the rotational motor is operatively connected to the gear assembly to impart rotational movement to the gear assembly causing the drum bracket and drum strainer to rotate.

6. The apparatus of claim 1, further comprising a motor configured to impart linear movement, the motor operatively connected to the spindle assembly to impart linear movement to at least the drum strainer and spindle assembly along the spindle assembly shaft.

7. The apparatus of claim 1, wherein the spindle shaft, scraper plate, front plate and inlet pipe remain substantially stationary during operation of the apparatus.

8. The apparatus of claim 1, further comprising a liquid waste discharge hose connected to the shroud.

9. The apparatus of claim 1, further comprising a discharge door positioned below the strainer drum, wherein the discharge door is operatively connected to the spindle assembly such that the spindle assembly causes the discharge door to move in the same linear direction with the drum strainer.

10. The apparatus of claim 1, wherein the strainer drum rotates at a sufficient rate to substantially separate liquid waste material from solid waste material, and the liquid waste is caused to be discharged through a plurality of openings in the strainer drum, wherein the liquid waste is constrained and directed by the shroud to the liquid waste discharge hose, and wherein the solid waste is caused to be discharged from the strainer drum interior region via a scrapping action of the scraper plate.

11. The apparatus of claim 1, wherein the face plate and scraper plate have a slightly smaller diameter than an internal diameter of the drum strainer.

12. The apparatus of claim 11, wherein a front portion and back portion of the drum strainer overlaps at least a portion of a perimeter edge of the face plate and the scraper plate respectively.

13. The apparatus of claim 1, wherein the scraper plate is held stationary as the drum strainer moves and is operative to perform a scraping action while the drum strainer is moved in a linear direction to remove accumulated solid waste from an interior of the drum strainer.

14. The apparatus of claim 1, wherein the rotational rate of the drum strainer is in the range of about 70 to about 80 revolutions per minute.

15. The apparatus of claim 1, wherein the rotational rate of the drum strainer is in the range of about 74 to about 85 revolutions per minute.

16. The apparatus of claim 6, wherein the spindle assembly and spindle assembly shaft are operatively engaged with one or more axial bearings to facilitate the liner movement of the spindle assembly along the spindle assembly shaft.

17. The apparatus of claim 1, wherein the opening at the top portion of the inlet pipe is connected to a sink.

18. The apparatus of claim 17, further comprising a valve positioned in the inlet pipe upper portion in proximity to the connection of the inlet pipe to the sink.

19. The apparatus of claim 18, wherein the valve comprises a ball valve.

20. The apparatus of claim 10, further comprising a solid waste collector positioned below the drum strainer and is configured to collect solid waste discharged from the strainer drum interior region.

21. The apparatus of claim 20, wherein the solid waste collector comprises a manual solid waste bagger.

22. The apparatus of claim 21, wherein the manual solid waste bagger comprises a continuous open sleeve of material and a sleeve tube, wherein the continuous open sleeve of material is accumulated in the sleeve tube.

23. The apparatus of claim 20, wherein the solid waste collector comprises an automatic solid waste bagger.

24. The apparatus of claim 23, wherein the automatic solid waste bagger comprises a continuous open sleeve of material; a sleeve tube, wherein the continuous open sleeve of material is accumulated in the sleeve tube; a sleeve advancement clamp operatively associated with and positioned below sleeve tube and configured to engage a portion of the continuous open sleeve of material to advance a defined length of continuous open sleeve of material from the sleeve tube; an upper sealer; a lower sealer; and a cutter, wherein the upper sealer, lower sealer, and cutter are in operative association with and positioned above the sleeve advancement clamp, and wherein the upper sealer is positioned below the lower sealer and the cutter is located between the upper sealer and the lower sealer, and wherein the upper sealer, lower sealer, and cutter comprise an assembly.

25. A system for separating mixed waste material into liquid and solid components comprising:
a housing;
a solid liquid separator housed in an interior region of the housing, the solid liquid separator comprising:
an inlet pipe having openings at a bottom portion and top portion thereof;
a front plate having an opening, wherein the front plate is connected to the inlet pipe at the inlet pipe opening, such that the front plate opening and the opening at the bottom portion of the inlet pipe align;
a drum strainer capable of rotational and linear movement;
a spindle assembly operatively connected to the drum strainer, wherein the spindle assembly facilitates the rotational and linear movement of the drum strainer;
a scraper plate fixed to an end portion of a shaft of the spindle assembly;
a shroud connected to the spindle assembly, wherein the shroud is spaced apart from and substantially covers the exterior surface of the drum strainer; and
wherein the drum strainer is positioned between the front plate and scraper plate; and
a solid waste wrap and seal compartment housed in the interior region of the housing and positioned below the solid liquid separator, wherein the solid waste wrap and seal compartment is configured to collect and seal solid waste material separated out from the solid liquid separator; and
a solid waste receptacle housed in the interior region of the housing and positioned below the solid waste wrap and seal compartment, wherein the solid waste receptacle is configured to collect sealed solid waste material from the solid waste wrap and seal compartment.

26. The system of claim 25, wherein the drum strainer, the front plate, and the scraper plate defining an interior region of the drum strainer within which mixed waste material is received via the inlet pipe.

27. The system of claim 25, wherein the front plate is connected to the inlet pipe such that it is perpendicular to a central axis of the opening at the bottom portion of the inlet pipe.

28. The system of claim 25, wherein the drum strainer is operatively connected to the spindle assembly by a drum bracket, wherein the drum bracket is operatively associated with one or more rotational bearings to allow rotational movement of the drum strainer about the shaft of the spindle assembly.

29. The system of claim 28, further comprising a rotational motor and a gear assembly, wherein the gear assembly is operatively connected to the drum bracket, and the rotational motor is operatively connected to the gear assembly to impart rotational movement to the gear assembly causing the drum bracket and drum strainer to rotate.

30. The system of claim 25, further comprising a motor configured to impart linear movement, the motor operatively connected to the spindle assembly to impart linear movement to at least the drum strainer and spindle assembly along the spindle assembly shaft.

31. The system of claim 25, wherein the spindle shaft, scraper plate, front plate and inlet pipe remain substantially stationary during operation of the apparatus.

32. The system of claim 25, further comprising a liquid waste discharge hose connected to the shroud.

33. The system of claim 25, further comprising a discharge door positioned below the strainer drum, wherein the discharge door is operatively connected to the spindle assembly such that the spindle assembly causes the discharge door to move in the same linear direction with the drum strainer.

34. The system of claim 25, wherein the strainer drum rotates at a sufficient rate to substantially separate liquid waste material from solid waste material, and the liquid waste is caused to be discharged through a plurality of openings in the strainer drum, wherein the liquid waste is constrained and directed by the shroud to the liquid waste discharge hose, and wherein the solid waste is caused to be discharged from the strainer drum interior region via a scrapping action of the scraper plate.

35. The system of claim 25, wherein the face plate and scraper plate have a slightly smaller diameter than an internal diameter of the drum strainer.

36. The system of claim 35, wherein a front portion and back portion of the drum strainer overlaps at least a portion of a perimeter edge of the face plate and the scraper plate respectively.

37. The system of claim 25, wherein the scraper plate is held stationary as the drum strainer moves and is operative to perform a scraping action while the drum strainer is moved in a linear direction to remove accumulated solid waste from an interior of the drum strainer.

38. The system of claim 25, wherein the rotational rate of the drum strainer is in the range of about 70 to about 80 revolutions per minute.

39. The system of claim 25, wherein the rotational rate of the drum strainer is in the range of about 74 to about 85 revolutions per minute.

40. The system of claim 30, wherein the spindle assembly and spindle assembly shaft are operatively engaged with one or more axial bearings to facilitate the liner movement of the spindle assembly along the spindle assembly shaft.

41. The system of claim 25, wherein the solid waste wrap and seal compartment comprises a manual solid waste bagger.

42. The system of claim 41, wherein the manual solid waste bagger comprises a continuous open sleeve of material and a sleeve tube, wherein the continuous open sleeve of material is accumulated in the sleeve tube.

43. The system of claim 25, wherein the solid waste wrap and seal compartment comprises an automatic solid waste bagger.

44. The system of claim 43, wherein the automatic solid waste bagger comprises a continuous open sleeve of material; a sleeve tube, wherein the continuous open sleeve of material is accumulated in the sleeve tube; a sleeve advancement clamp operatively associated with and positioned below sleeve tube and configured to engage a portion of the continuous open sleeve of material to advance a defined length of continuous open sleeve of material from the sleeve tube; an upper sealer; a lower sealer; and a cutter, wherein the upper sealer, lower sealer, and cutter are in operative association with and positioned above the sleeve advancement clamp, and wherein the upper sealer is positioned below the lower sealer and the cutter is located between the upper sealer and the lower sealer, and wherein the upper sealer, lower sealer, and cutter comprise an assembly.

45. The system of claim 25, wherein the housing further comprises a lid, wherein the lid provides access to the opening at the top portion of the inlet pipe.

46. The system of claim 25, wherein the housing further comprises a liquid waste container fluidly connected to the liquid waste discharge hose.

47. The system of claim 25, wherein the housing further comprises a solid waste receptacle housing, wherein the solid waste receptacle is house therein.

48. The system of claim 25, wherein the liquid waste container comprises a liquid level indicator.
